(19) United States
(12) Patent Application Publication
(10) Pub. No.: US 2005/0277425 A1
(43) Pub. Date: Dec. 15, 2005

(54) Method of controlling data transmission, radio system, controller, and base station

(76) Inventors: Kari Niemela, Oulu (FI); Jari Hulkkonen, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/867,167

(22) Filed: Jun. 15, 2004

(51) Int. Cl. H04Q 7/00

(52) U.S. Cl. 455/452.2

(57) ABSTRACT

There is provided a radio system comprising a controller for controlling at least one base stations, a user terminal communicating with one or more base stations, and a serving base station for controlling data transmission of the user terminal over a control channel. The controller is configured to detect one or more interfering base stations of the user terminal, and to provide information on suppression of downlink transmission for the one or more interfering base stations of the user terminal; and the one or more interfering base stations are configured to suppress downlink transmission by controlling downlink transmission power of the interfering base stations at predetermined time intervals on the basis of the provided information from the controller when the user terminal receives downlink control channel transmission from the serving base station.

### BACKGROUND OF THE INVENTION

1. Field of the Invention

The invention relates to a method of controlling data transmission in a radio system, to a radio system, to a controller, and to a base station.

2. Description of the Related Art

In known radio systems, the adaptive multi-rate speech codec (AMR) capacity is limited by control channel performance for the most robust fullrate AMR codecso. Interfering cells of neighbouring base stations of a user terminal cause interference to downlink control channel transmission from a serving base station to the user terminal.

For example, if a user terminal is not receiving a slow associated control channel (SACCH) correctly due to interference, it may drop a call due to Radio Link Timeout (RLT) mechanism. A call may be dropped even if AMR frame error rate (FER) is close to 0, i.e. speech quality is very good. For example, the AMR capacity is crucially limited by downlink SACCH performance. Thus, the AMR capacity gains cannot be obtained in real networks without solving the downlink SACCH performance issues.

### SUMMARY OF THE INVENTION

According to an aspect of the invention, there is provided a method of controlling data transmission in a radio system, the radio system comprising a controller for controlling at least one base station, and a user terminal communicating with one or more base stations. The method comprising: detecting, by the controller, one or more interfering base stations of the user terminal; providing, by the controller, information on suppression of downlink transmission for the one or more interfering base stations of the user terminal; suppressing, by the one or more interfering base stations, downlink transmission by controlling the downlink transmission power of the interfering base stations at predetermined time intervals on the basis of the provided information from the controller when the user terminal receives downlink control channel transmission from the serving base station.

According to an embodiment of the invention, there is provided a radio system comprising a controller for controlling at least one base station, a user terminal communicating with one or more base stations, and a serving base station for controlling data transmission of the user terminal over a control channel. The controller is configured to detect one or more interfering base stations of the user terminal, and to provide information on suppression of downlink transmission for the one or more interfering base stations of the user terminal; and the one or more interfering base stations are configured to suppress downlink transmission by controlling downlink transmission power of the interfering base stations at predetermined time intervals on the basis of the provided information from the controller when the user terminal receives downlink control channel transmission from the serving base station.

According to an embodiment of the invention, there is provided a controller of a radio system, the controller communicating with at least one base station, and comprising a processing unit for controlling the functions of the controller. The processing unit is configured to detect one or more interfering base stations of the user terminal, and to provide information on suppression of downlink transmission for the one or more interfering base stations of the user terminal for enabling the one or more interfering base stations to suppress downlink transmission by controlling the downlink transmission power of the interfering base stations at predetermined time intervals on the basis of the provided information from the controller when the user terminal receives downlink control channel transmission from the serving base station.

According to an embodiment of the invention, there is provided a base station of a radio system, the base station comprising one or more transceivers for communicating with a controller and a user terminal, and a processing unit for controlling the functions of the base station, the base station being an interfering base station to the user terminal. The transceiver is configured to receive information on suppression of downlink transmission from the controller; and the processing unit is configured to suppress downlink transmission by controlling the downlink transmission power of the interfering base stations at predetermined time intervals on the basis of the received information from the controller when the user terminal receives downlink control channel transmission from the serving base station.

According to yet another embodiment of the invention, there is provided a radio system comprising a controller for controlling at least one base stations, a user terminal communicating with one or more base stations, and a serving base station for controlling data transmission of the user terminal over a control channel. The controller comprising detecting means for detecting one or more interfering base stations of the user terminal, and transmitting means for providing information on suppression of downlink transmission for the one or more interfering base stations of the user terminal; and the one or more interfering base stations comprising controlling means for suppressing downlink transmission by controlling the downlink transmission power of the interfering base stations at predetermined time intervals on the basis of the provided information from the controller when the user terminal receives downlink control channel transmission from the serving base station

The embodiments of the invention provide several advantages. The interference load towards the desired radio channel is minimized. Thus, the radio channel performance is improved, and information transmitted on a radio channel is received correctly.

### BRIEF DESCRIPTION OF THE DRAWINGS

In the following, the invention will be described in greater detail with reference to the preferred embodiments and the accompanying drawings, in which

FIG. 1 is a simplified block diagram illustrating the structure of a radio system;

FIG. 2 is another example illustrating the structure of a radio system; and

FIG. 3 illustrates a method of controlling data transmission in a radio system.

### DETAILED DESCRIPTION OF THE PREFERRED EMBODIMENTS

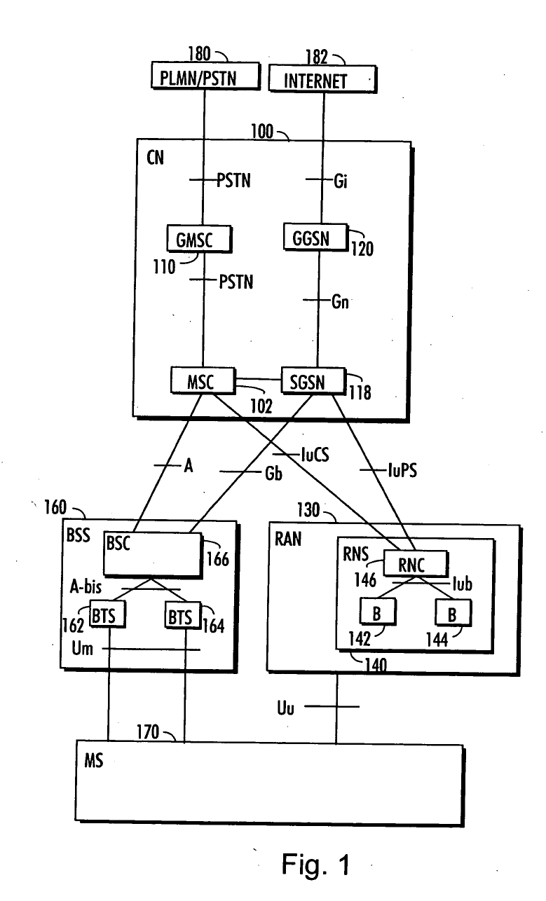

FIG. 1 is a simplified block diagram, which shows the most important parts of a radio system and the interfaces between them at network element level. The main parts of a radio system are a core network (CN) 100, a radio access network 130 and user terminal 170. The radio access network 130 may be implemented by wideband code division multiple access (WCDMA) technology. The structure and functions of the network elements are not described in detail, because they are generally known.

Mobile services switching centre (MSC) 102 is a mobile network element that can be used to serve the connections of both radio access network and a base station system 160. The tasks of the mobile services switching centre 102 include: switching, paging, user terminal location registration, handover management, collection of subscriber billing information, encryption parameter management, frequency allocation management, and echo cancellation. The number of mobile services switching centres 102 may vary: a small network operator may only have one mobile services switching centre 102, but in large core networks 100, there may be several.

Large core networks 100 may have a separate gateway mobile ser-vices switching centre (GMSC) 110, which takes care of circuit-switched connections between the core network 100 and external networks 180. The gateway mobile services switching centre 110 is located between the mobile ser-vices switching centre 102 and the external networks 180. An external network 180 can be for instance a public land mobile network (PLMN) or a public switched telephone network (PSTN).

A serving GPRS support node (SGSN) 118 is the centre point of the packet-switched side of the core network 100. The main task of the serving GPRS support node 118 is to transmit and receive packets with mobile station 170 supporting packet-switched transmission by using the base station system 160. The serving GPRS support node 118 contains subscriber and location information related to the user terminal 170.

A gateway GPRS support node (GGSN) 120 is the packet-switched side counterpart to the gateway mobile services switching centre of the circuit-switched side with the exception, however, that the gateway GPRS support node 120 is also capable of routing traffic from the core network 100 to external networks 182, whereas the gateway mobile services switching centre only routes incoming traffic. In our example, the Internet represents external networks 182.

The base station system 160 comprises a base station controller (BSC) 166 and base transceiver stations (BTS) 162, 164. The base station controller 166 controls the base transceiver station 162, 164. Oftentimes the devices implementing the radio path and their functions reside in the base transceiver station 162, 164, and control devices reside in the base station controller 166.

The base station controller 166 takes care of the following tasks, for instance: radio resource management of the base transceiver station 162, 164, intercell handovers, frequency control, i.e. frequency allocation to the base transceiver stations 162, 164, management of frequency hopping sequences, time delay measurement on the uplink, implementation of the operation and maintenance interface, and power control.

The base transceiver station 162, 164 contains at least one transceiver, which provides one carrier, i.e. eight time slots, i.e. eight physical channels. Typically, one base transceiver station 162, 164 serves one cell, but it is also possible to have a solution in which one base transceiver station 162, 164 serves several sectored cells. The tasks of the base transceiver station 162, 164 include: calculation of timing advance (TA), uplink measurements, channel coding, encryption, decryption, and frequency hopping.

The radio access network 130 is made up of radio network subsystems 140. Each radio network subsystem 140 is made up of radio network controllers 146 and B nodes 142, 144. A B node is a rather abstract concept, and often the term base transceiver station is used instead of it.

The user terminal 170 comprises at least one transceiver for establishing a radio link to the base station system 160. The user terminal 170 can contain different subscriber identity modules. In addition, the user terminal 170 contains an antenna, a user interface and a battery. Today, there are different types of user terminals 170, for instance equipment installed in cars and portable equipment. Features better known from personal or portable computers have also been implemented in the user terminal 170.

In UMTS, the most important interfaces are the Iu interface between the core network and the radio access network, which is divided into the interface IuCS on the circuit-switched side and the interface IuPS on the packet-switched side, and the Uu interface between the radio access network and the user equipment. In GSM/GPRS, the most important interfaces are the A interface between the base station controller and the mobile services switching center, the Gb interface between the base station controller and the serving GPRS support node, and the Um interface between the base transceiver station and the user terminal. The Um interface is the GPRS network interface for providing packet data services over the radio to the mobile station. The interface defines what kind of messages different network elements can use in communicating with each other.

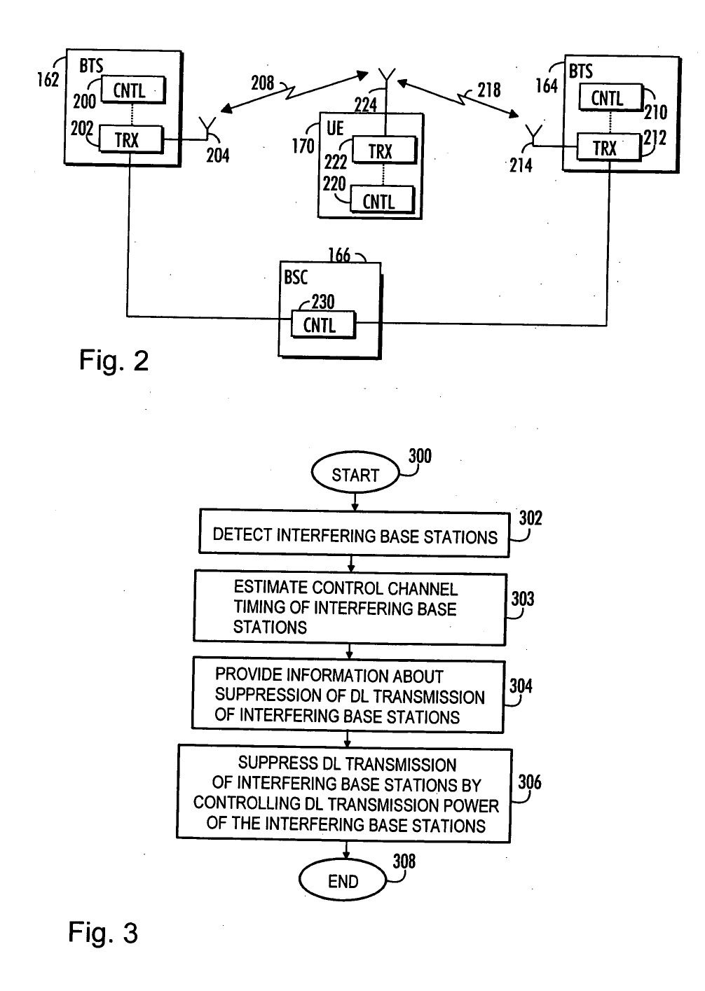

In the example of FIG. 2, the first base station 162 comprises a transceiver 202, an antenna 204 and a processing unit 200. Similarly, the second base station 164 comprises a transceiver 212, an antenna 214 and a processing unit 210. The base station controller 166 also comprises a processing unit 230. The user terminal 170 also comprises a normal transceiver 222 and an antenna 224 for establishing a radio link 208, 218, and a processing unit 220. The transceivers 202, 212, 222 may use TDMA technology, and for instance a normal GSM system GMSK (Gaussian Minimum Shift Keying) modulation or EDGE modulation, i.e. 8-PSK (8 Phase Shift Keying) modulation. The antennas 204, 214, 224 can be implemented by normal prior art, for instance as omni directional antennas or antennas using a directional antenna beam.

The processing units 200, 210, 220, 230 refer to blocks controlling the operation of the device, which today are usually implemented using a processor with software, but different hardware implementations are also possible, such as a circuit made of separate logic components or one or more application-specific integrated circuits (ASIC). A combination of these methods is also possible.

The GPRS radio interface comprises independent uplink and downlink channels. The downlink carries transmissions from the network to multiple user terminals, and the uplink is shared among multiple user terminals for transmissions in which the user terminal transmits and the base transceiver station receives.

Let us assume that the first base station 162 is a serving base station of the user terminal 170. Downlink data transmission from the base station subsystem to the user terminal 170 is performed via the serving base station 162. However, there may be one or more interfering base stations, for example the second base station 164, that cause interference to the downlink transmission.

In an embodiment, the base station controller 166, hence referred to as a controller, is configured to detect one or more interfering base stations 164 of the user terminal 170, and to provide information on suppression of downlink transmission for the one or more interfering base stations 164 of the user terminal 170. The one or more interfering base stations 164 are configured to suppress downlink transmission of the one or more interfering base stations 164 by controlling the downlink transmission power of the interfering base stations 164 at predetermined time intervals on the basis of the provided information from the controller 166 when the user terminal 170 receives downlink control channel transmission from the serving base station 162.

In an embodiment, the interfering base station 164 is configured to suppress the downlink transmission by reducing the downlink transmission power of bursts occurring at predetermined time intervals. In another embodiment, the interfering base station 164 is configured to suppress the downlink transmission by eliminating the downlink transmission power of bursts occurring at predetermined time intervals.

In an embodiment, the controller 166 provides information about timing (FN MOD 26) and magnitude of suppression (dB or OFF) for the serving base station 162. There can also be one or more interfering cells of interfering base stations 164, and thus more than one timing values may have to be suppressed.

In an embodiment, the controller 166 is configured to detect the one or more interfering base stations 164 by estimating the interfering base stations on the basis of measurement reports received from the user terminal 170. In an embodiment, the controller 166 is further configured to estimate control channel timing of the interfering base stations 164 when one or more interfering base stations are detected. The controller 166 may estimate the potential interfering cells of the interfering base stations 164 and the timing based on the measurement reports. In synchronized networks, timing information from the user terminal 170 is not necessarily needed. The measurement reports from the user terminal 170 can be used to estimate potential interfering base stations from neighbouring cell reports, for example. The controller 166 may filter the measurement reports from many user terminals 170 for receiving reliable estimates of interfering base stations 164. SACCH timing on the interfering base stations can be estimated on the basis of an OTD (Observed Time Difference) value of the DL measurement reports, additionally RTD Real Time Difference information can be used for better timing accuracy. In a synchronised network, the timing is known on the basis of a timing offset value.

In an embodiment, the downlink control channel is a slow associated control channel (SACCH), and the interfering base station 164 is configured to suppress the downlink transmission power by reducing the downlink power of bursts occurring every 120 milliseconds.

In an embodiment, the trade-off between the desired signal frame error rate and the interfered user terminal call dropping can be adjusted by suppression of the dB value and a number of interfered cells. It is assumed that the AMR full-rate is so robust that one burst out of eight could be suppressed without introducing significant frame error rate increases. The maximum suppression in dB has to be low enough so that the operation of AGC of user terminal 170 is not disturbed. The AMR gains can also be obtained for legacy AMR user terminals 170.

Let us next study the example of FIG. 3 illustrating a data transmission controlling method. The method starts in 300. In 302, the controller detects one or more interfering base stations of a user terminal. In 303, the controller estimates control channel timing of the interfering base stations. In 304, the controller provides information on suppression of downlink transmission for the one or more interfering base stations of the user terminal. In 306, the one or more interfering base stations suppress downlink transmission by controlling the downlink transmission power of the interfering base stations at predetermined time intervals on the basis of the provided information from the controller when the user terminal receives downlink control channel transmission from the serving base station. The method ends in 308.

The improvements on the control channel have impacts on Drop Call Rate (DCR) that is based on Radio Link Timeout. For example, if SACCH is improved 2 dB, the number of dropped calls is clearly lower. The network load can, for example, be increased by about 50% to maintain reference SACCH DCR. An average 2 dB improvement in SACCH C/I performance may reduce the number of RLT based DCRs. This can be estimated by calculating a fixed 2 dB improvement in SACCH C/I performance for every SACCH block, for example.

Thus, the method enables suppression of the transmission power of interfering base stations when the interfering base stations disturb SACCH signalling periods of another base station. The method can be used in the controller for controlling the transmission power of interfering base stations. To optimise the desired control channel C/l, the maximum available transmission power for the desired control channel transmission can be used.

Even though the invention is described above with reference to an example according to the accompanying drawings, it is clear that the invention is not restricted thereto but it can be modified in several ways within the scope of the appended claims.

1. A method of controlling data transmission in a radio system, the radio system comprising a controller for controlling at least one base station, and a user terminal communicating with one or more base stations, the method comprising:
detecting, by the controller, one or more interfering base stations of the user terminal;
providing, by the controller, information on suppression of downlink transmission for the one or more interfering base stations of the user terminal;
suppressing, by the one or more interfering base stations, downlink transmission by controlling the downlink transmission power of the interfering base stations at predetermined time intervals on the basis of the provided information from the controller when the user terminal receives downlink control channel transmission from the serving base station.

2. The method of claim 1, the step of suppressing the downlink transmission of the one or more interfering base stations comprising reducing the downlink transmission power of bursts occurring at predetermined time intervals.

3. The method of claim 1, the step of suppressing the downlink transmission of the one or more interfering base stations comprising eliminating the downlink transmission power of bursts occurring at predetermined time intervals.

4. The method of claim 1, the step of detecting one or more interfering base stations comprising estimating the interfering base stations on the basis of measurement reports received from the user terminal.

5. The method of claim 1, the downlink control channel being a slow associated control channel, and the step of suppressing the downlink transmission power of the interfering base stations comprising reducing the downlink power of bursts occurring every 120 milliseconds.

6. The method of claim 1, the method further comprising estimating, by the controller, the control channel timing of the interfering base stations when one or more interfering base stations are detected.

7. A radio system comprising a controller for controlling at least one base station, a user terminal communicating with one or more base stations, and a serving base station for controlling data transmission of the user terminal over a control channel, wherein:
the controller is configured to detect one or more interfering base stations of the user terminal, and to provide information on suppression of downlink transmission for the one or more interfering base stations of the user terminal; and
the one or more interfering base stations are configured to suppress downlink transmission by controlling the downlink transmission power of the interfering base stations at predetermined time intervals on the basis of the provided information from the controller when the user terminal receives downlink control channel transmission from the serving base station.

8. The radio system of claim 7, wherein the one or more interfering base stations are configured to suppress the downlink transmission of the one or more interfering base stations by reducing the downlink transmission power of bursts occurring at predetermined time intervals.

9. The radio system of claim 7, wherein the one or more interfering base stations are configured to suppress the downlink transmission of the one or more interfering base stations by eliminating the downlink transmission power of bursts occurring at predetermined time intervals.

10. The radio system of claim 7, wherein the controller is configured to detect one or more interfering base stations by estimating the interfering base stations on the basis of measurement reports received from the user terminal.

11. The radio system of claim 7, wherein the downlink control channel is a slow associated control channel, and the one or more interfering base stations are configured to suppress the downlink transmission power of the interfering base stations by reducing the downlink power of bursts occurring every 120 milliseconds.

12. The radio system of claim 7, wherein the controller is further configured to estimate the control channel timing of the interfering base stations when one or more interfering base stations are detected.

13. A controller of a radio system, the controller communicating with at least one base station, and comprising a processing unit for controlling the functions of the controller, wherein:
the processing unit is configured to detect one or more interfering base stations of the user terminal, and to provide information on suppression of downlink transmission for the one or more interfering base stations of the user terminal for enabling the one or more interfering base stations to suppress downlink transmission by controlling the downlink transmission power of the interfering base stations at predetermined time intervals on the basis of the provided information from the controller when the user terminal receives downlink control channel transmission from the serving base station.

14. The controller of claim 13, wherein the processing unit is configured to detect one or more interfering base stations by estimating the interfering base stations on the basis of measurement reports received from the user terminal.

15. The controller of claim 13, wherein the processing unit is configured to estimate control channel timing of the interfering base stations when one or more interfering base stations are detected.

16. A base station of a radio system, the base station comprising one or more transceivers for communicating with a controller and a user terminal, and a processing unit for controlling the functions of the base station, the base station being an interfering base station to the user terminal, wherein:
the transceiver is configured to receive information on suppression of downlink transmission from the controller; and the processing unit is configured to suppress downlink transmission by controlling the downlink transmission power of the interfering base stations at predetermined time intervals on the basis of the received information from the controller when the user terminal receives downlink control channel transmission from the serving base station.

17. The base station of claim 16, wherein the processing unit is configured to suppress the downlink transmission of the interfering base station by reducing the downlink transmission power of bursts occurring at predetermined time intervals.

18. The base station of claim 16, wherein the processing unit is configured to suppress the downlink transmission of the interfering base station by eliminating the downlink transmission power of bursts occurring at predetermined time intervals.

19. The base station of claim 16, wherein the downlink control channel is a slow associated control channel, and the processing unit is configured to suppress the downlink transmission power of the interfering base station by reducing downlink power of bursts occurring every 120 milliseconds.

20. A radio system comprising a controller for controlling at least one base station, a user terminal communicating with one or more base stations, and a serving base station for controlling data transmission of the user terminal over a control channel,
the controller comprising detecting means for detecting one or more interfering base stations of the user terminal, and transmitting means for providing information on suppression of downlink transmission for the one or more interfering base stations of the user terminal; and
the one or more interfering base stations comprising controlling means for suppressing downlink transmission by controlling the downlink transmission power of the interfering base stations at predetermined time intervals on the basis of the provided information from the controller when the user terminal receives downlink control channel transmission from the serving base station.
